(19) United States
(12) Patent Application Publication
(10) Pub. No.: US 2010/0179817 A1
(43) Pub. Date: Jul. 15, 2010

(54) SEARCH, RETRIEVAL, DESIGN MANAGEMENT METHODS AND SYSTEMS

(75) Inventors: Edwin Wold, Mesa, AZ (US); Brooke Wold, Mesa, AZ (US)

Correspondence Address: Edwin Wold, 3746 E. Covina St., Mesa, AZ, 85205, US

(73) Assignee: WOLD & WOLD LLC, Mesa, AZ (US)

(21) Appl. No.: 12/645,035

(22) Filed: Dec. 22, 2009

Related U.S. Application Data
(60) Provisional application No. 61/204,967, filed on Jan. 13, 2009.

(51) Int. Cl. G06F 17/30; G06F 17/00; G06Q 99/00; G06Q 30/00

(52) U.S. Cl. 705/1.1; 707/780; 715/212; 707/E17.014; 707/769

(57) ABSTRACT

An apparatus for interactively displaying and presenting a patent or engineering search. Users for the present invention may include patent searchers/entities, patent attorneys, patent agents, engineering and design firms, research and development entities, examiners, patent portfolio managers, marketers, independent inventors, investors and other professionals involved within the field of intellectual property. Hyperlinks and text are used to create an interactive, efficient search whereby the users may rapidly view and analyze the prior art or competitive product(s). The design process may be tailored upon the results to avoid infringement. The present invention may be used in the patenting process and be presented and managed throughout the life of the patent.

### CROSS-REFERENCE TO RELATED APPLICATION

The present application is related to and claims priority from prior provisional application Ser. No. 61/204,967, filed Jan. 13, 2009 and to US publication 2009/0210245 filed Dec. 24, 2008 claiming benefit of prior provisional application Ser. No. 61/009,417, filed Dec. 28, 2007 which applications are incorporated herein by reference.

### BACKGROUND OF THE INVENTION

1. Technical Field

The present invention relates generally to the field of searching and retrieval and more specifically relates to the efficient search, retrieval, reference, design and management of relevant images and data for patent art used in the research and design of novel engineered products.

2. Background Art

Images and text may be searched to find solutions to problems and to analyze and compare the state of the art to facilitate innovation and to track competitive pursuits. Typically, art such as patent art found in patents and trademarks may provide a means whereby an inventor or R & D business entity may check and gauge what they are developing against what has been disclosed through figures including drawings, flowcharts and textual applications in issued patents and trademarks.

Traditionally, search persons have used keywords, search strings and drawn images to search data on databases such as those accessed through the USPTO, Espace, CIPO and other such websites. Other databases such as MicroPatent and other commercial databases are also available for this purpose. A searcher then compiles the most relevant data collected during the search and organizes it according to relative significance to the art being searched. The data is then analyzed from the physical document and a decision is made whether to proceed or not based on these findings. Many times applicable data may be missed during the search or missed during the analysis of the search. Further, the search cannot be easily compared visually to the proposed invention, thereby risking future legal infringement of patented designs.

Traditionally, management of patent portfolios, R & D engineering, marketing and product portfolios of large and small entities have been difficult to efficiently track and difficult to accurately compare with competitor's products. Problems may arise that stymie design, research and development due to these inaccuracies and the low effectiveness of the present methods.

Ideally, a search, retrieval, and design management method and system should accurately and interactively provide data in a logical format whereby an entity may efficiently and readily assess the data compiled and make a reasonable educated-informed decision or design based on the information provided. Thus, a need exists for a reliable interactive search, retrieval, design and management method and system to avoid the above-mentioned problems.

### BRIEF SUMMARY OF THE INVENTION

In view of the foregoing disadvantages inherent in the known search, retrieval and design art, the present invention provides a novel system for providing R & D with accurate and efficient parameters to design novel engineered products. The general purpose of the present invention, which will be described subsequently in greater detail is to provide a search, retrieval and design management method and system. The present invention holds significant improvements and serves as a search, retrieval, design management method and system.

The present invention is a search, retrieval, design management method and system comprising: a computer system; an internet communicator; a connecter providing connection means to the internet by hardwired or wireless means; with an accessible database preferably comprising data; inputting means comprising at least one inputter connected to the computer system. This permits at least one user to input the data into the computer system which is connected by the internet communicator to the database. Output means from the computer system may include at least one monitor, at least one speaker that may be used to alert the user. The search, retrieval and management method and system may provide an interactive search analyzing means using hyperlinks.

The search, retrieval, management method and system uses the interactive search analyzing means for engineering design analysis by using the at least one hyperlink. The interactive search analyzing means may be used to assist with patent portfolio management. A hyperlink may be used to assist displaying at least one patent document. Another hyperlink may also be used to assist displaying at least one patent figure or image. The hyperlink may be further used to assist displaying at least one file wrapper.

The interactive search analyzing means may comprise presenting means for marketing and for comparative analysis using a user-defined parameter set. The user-defined parameter set may comprise statistical means. A spreadsheet may be compiled on at least one spreadsheet application software program and be compiled with the interactive data to allow the user to interact with the program and the databases.

At least one text document may be compiled on at least one word processing software program that is linked with the spreadsheet which is compiled with the interactive data. At least one presentation may be compiled on at least one presentation software program used by the present invention that may also be linked to the word processing software program and the spreadsheet program.

Project management and tracking means using at least one project management software program may be employed. An interactive search may be compiled by using at least one combination of the spreadsheet application software program, the word processing software program, the presentation software program, and/or at least one project management software program to create interactive search document(s) that may be used for a variety of purposes as described herein.

The search, retrieval, design management method and system may use the project management software further comprising alerting means connected to critical patent dates to alert user(s). Alerting means may comprise at least one text color change; at least one audible alert; and/or at least one text alert. The above may be used in various combinations with each other to provide an alerting means.

A method of use is described herein for the present invention comprising the steps of: a searcher searching the at least one database; next the searcher may compile the spreadsheet with relevant data and hyperlinks; followed by the user opening the spreadsheet and analyzing its contents for relevance against a proposed idea and/or R & D design to assist in determining novelty; the next step may include comparing the contents of the spreadsheet including the hyperlinked figures, text and claims against a proposed idea and/or R & D design to analyze the potential invention for infringement and design accordingly. The analysis may comprise a grading system that has user-defined parameters. Once the invention has been substantially designed and/or reverse engineered a patent professional or independent inventor may further analyze the proposed novelties in regard to the invention and design using the spreadsheet to create at least one patent application using the information provided. Next marketing may be accomplished using the present invention for the proposed invention and/or provisional patent/non-provisional patent using at least one presentation program. Project managing using project management software may be employed to track the design and engineering of the proposed invention, as well as the patent may be managed using the project management software to track the patent through the examination process and throughout the lifetime of the patent in a patent portfolio. The present invention described herein may also be used to track patents of various competitive entities.

The present invention holds significant improvements and serves as a search, retrieval, design management method and system. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, search, retrieval, design management method and system.

FIG. 1 shows a perspective view, illustrating a computer system as used for a search, retrieval, design and management method and system, according to a preferred embodiment of the present invention.

FIG. 2 is a perspective view, illustrating a screen shot view of the search, retrieval, design and management method and system as used in a searching process, according to a preferred embodiment of the present invention of FIG. 1.

FIG. 3 is a perspective view, illustrating a screen shot view of the search, retrieval, design and management method and system as used in a design and/or analysis process, according to a preferred embodiment of the present invention of FIG. 1.

FIG. 4 is a perspective view, illustrating a screen shot view of the search, retrieval, design and management method and system as used in a research and design process, according to a preferred embodiment of the present invention of FIGS. 1-3.

FIG. 5 is a perspective view, illustrating a screen shot view of the search, retrieval, design and management method and system as used in a patent writing process, according to a preferred embodiment of the present invention of FIG. 1.

FIG. 6 is a perspective view, illustrating a screen shot view of the search, retrieval, design and management method and system as used in a marketing process, according to a preferred embodiment of the present invention of FIG. 1.

FIG. 7 is a perspective view, illustrating a screen shot view of the search, retrieval, design and management method and system as used in a management process according to a preferred embodiment of the present invention of FIG. 1.

FIG. 8 is a perspective view, illustrating a screen shot view of the search, retrieval, design and management method and system as used, according to a preferred embodiment of the present invention of FIG. 1.

FIG. 9 is a flowchart, illustrating a preferred method of use of the search, retrieval, design and management method and system, according to a preferred embodiment of the present invention of FIGS. 1-8.

The preferred embodiments of the present invention will hereinafter be described in conjunction with the appended drawings, wherein like designations denote like elements.

### DETAILED DESCRIPTION

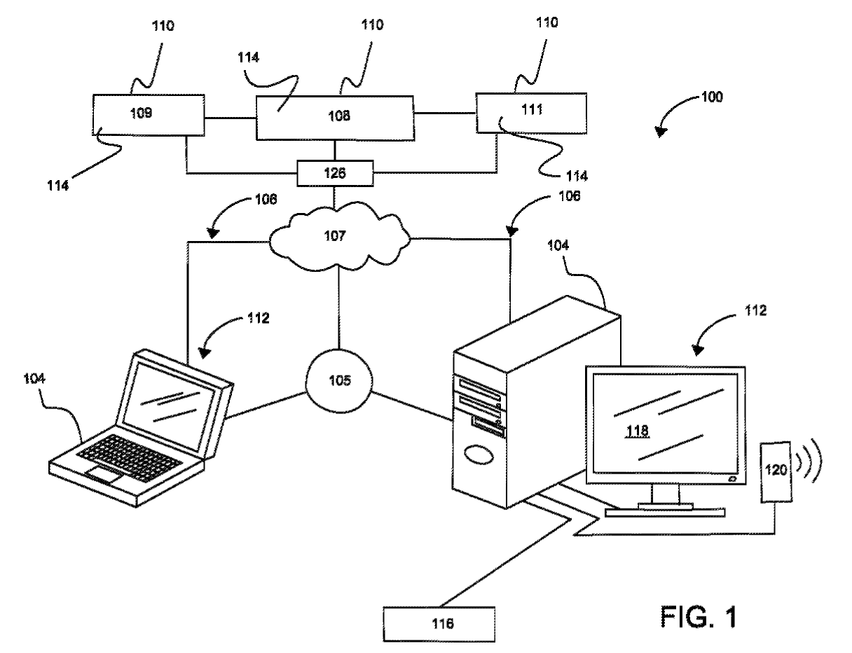

As discussed above, embodiments of the present invention relate to a search, retrieval, design and management method and system and more particularly relates to the efficient search, retrieval, reference, design and management of relevant images and data for patent art used for research and design of novel engineered products. Referring to the drawings by numerals of reference there is shown in FIG. 1, a perspective view, illustrating computer system 104 as used for search, retrieval, design and management method and system 100, according to a preferred embodiment of the present invention.

Search, retrieval, design and management method and system 100 is disclosed herein preferably comprising: at least one computer system 104; at least one internet communicator 106, at least one intranet connection 105 providing connection means to internet 107 via hardwired, wireless or other suitable means; at least one accessible database 110 preferably comprising data 114. Inputting means may include at least one inputter 116 such as a mouse, lightpen, keyboard, touch-screen or other input means connected to computer system 104 and permits at least one user to input data 114 into computer system 104 which is connected by internet communicator 106 to database 110. Output means from computer system 104 may include at least one monitor 118, at least one speaker 120 and other suitable means or combinations to communicate and/or alert at least one user or group of attendees.

Within a preferred embodiment of the present invention a user(s) may search databases 110 for relevant data 114 to at least one search query. For example a user may be searching for prior art as related to a proposed idea for a potentially patentable idea/invention. User preferably enters input into computer system 104 such as keywords, search strings and/or draws images to try parse out related data from data 114 in database 110 such as relevant patents, applications, trademarks and other documents from patent database 108. In a similar manner search, retrieval design and management method and system 100 may be used to search other databases 110 with other products and services such as engineering drawings on engineering specific database 109. Databases 110 drawn from in the present invention may include USPTO, Espace, WIPO and other individual country patent and trademark website databases 110 as well as Google Patents and other suitable commercial databases 110. It should also be noted that searches may be made on various search engines to obtain data 104 relevant to the search and/or design parameters of for example competitors products.

Databases 110 may also include non-patent literature databases 111 such as Web of Science, DialoguePro, Engineering specific databases 109 relating to the various disciplines of engineering and design, as shown. Upon reading this specification, it should be noted that, under appropriate circumstances, when considering such issues as user, design, and marketing preferences, cost considerations, structural requirements, available materials, technological advances, etc., other applications and arrangements in various industries and technologies such as, for example, mechanical engineering design and drafting, civil engineering applications such as land and utility location drawings, land development, electrical engineering, aeronautical and aerospace engineering, welding engineering, power engineering, design and simulation, for use with sign makers, graphic artists, furniture designers and builders, etc., may present a suitable alternative.

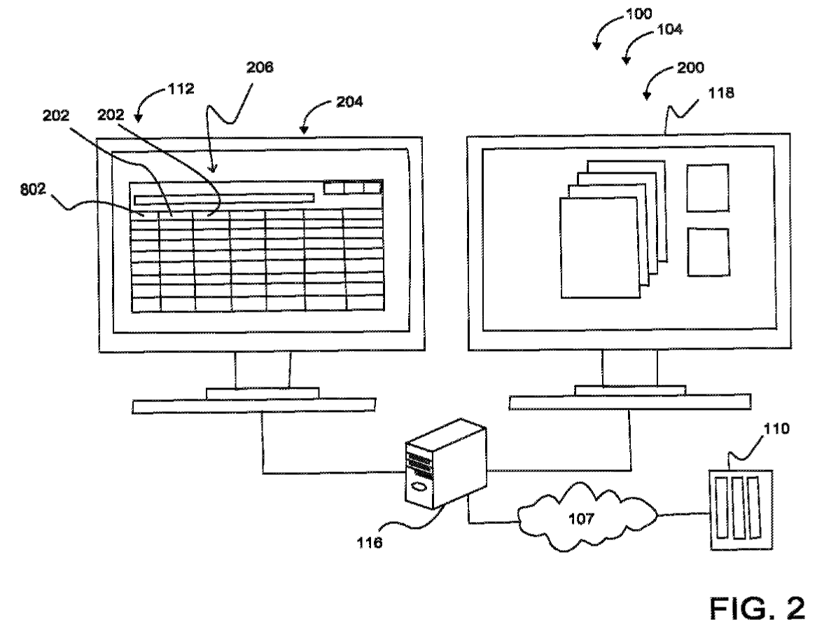

Referring now to FIG. 2, showing a perspective view illustrating a screen shot view 112 of search, retrieval, design and management method and system 100 as used in a searching process 200, according to a preferred embodiment of the present invention of FIG. 1.

Screen shot view 112 illustrates searching process 200 as used within the present invention. Searching process 200 preferably comprises actively or passively searching database(s) 110 for relevant data 114. Passive searching may be performed using a search bot within one of the preferred embodiments of the present invention. A user may search independently or in combination with another user connected through at least one intranet connection 105 and/or at least one internet 107, preferably connected as shown in FIG. 1. Data 114 may be preferably compiled in a logical order as information is discovered. Data 114 may be viewed and stored according to a tiling process whereby images, documents may be selected and categorized as to importance, for example good, better, best, in which good would be stored for later reference, better would be stored separately as probable final selections and best, going directly to the final selection to be put in the final document.

Data 114 may also be saved in documents 204 such as for example those used for Microsoft Word whereby a text document may be compiled on at least one word processing software program; Excel (shown as spreadsheet 206), including the ability to perform calculations, use of graphing tools, pivot tables, macro programming language as a spreadsheet application software program; and PowerPoint, Project and/or other suitable software program(s) or combination of programs. For example the user may save the information in a Word document and an excel document that interact with a PowerPoint document and Project for making interactive presentations. Those with ordinary skill in the art will now appreciate that upon reading this specification and by their understanding the art of linking software as described herein, methods of linking software programs to be used in combination will be understood by those knowledgeable in such art. It should also be understood that various combinations of the above-mentioned software programs may be user-specified according to preference and the software mentioned herein is described for exemplary means only, that other programs and/or software may also be used and the present invention is not intended to be limited by such disclosure.

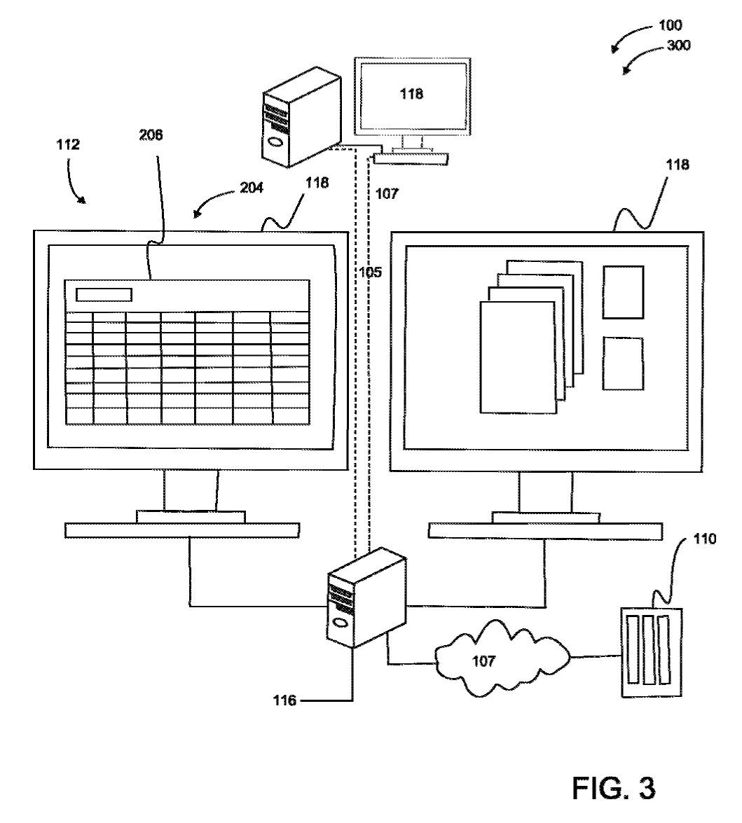

Preferably, the links to these documents 204 may be saved as hyperlinks 202 so the user can directly and quickly view patent(s) or other document(s) of interest that have been selected, with substantial ease, to make a final decision on the relevance and then enter remaining data 114 into document 204. Hyperlinks 202 may be preferably used as at least one navigation element within the original document to another section of the same document(s) or to another document(s) that may be on or part of a different domain. Examples of data 114 that may be entered into document 204 is shown and discussed further in FIG. 3. It should be appreciated that other suitable present and future navigation means or versions of hyperlinks 202 such as hyperlinks with anchors, hyperlinks with directions, bi-directional hyperlinks, many-to-many links, inline links, hot areas, images and/or video and/or text pasted into documents, icons, and use of hyperlinks from various and to various sites may also be used within the spirit and scope of the present invention. In this way the present invention comprises at least one hypertext system. Hyperlinks 202 within the present invention may be embedded or non-embedded. Hyperlinks 202 may preferably comprise at least one user-specified link destination, a label, a title, a target and a link I.D.

Referring now to FIG. 3, showing a perspective view illustrating a screen shot view 112 of search, retrieval, design and management method and system 100 as used in design and analysis process 300, according to a preferred embodiment of the present invention of FIG. 1.

Once data 114 has been entered into at least one document as described above, search, retrieval, design and management method and system 100 may be used to analyze prior art and compiled searches in the following ways: analysis process 300 may comprise the user opening hyperlinks 202, or other linking means, whereby an image and/or text is available for viewing. For example these images and/or text may comprise presentations of R & D projects and compare the projects to issued patents, publications, products for sale on internet 107 and other such relevant comparisons available. Further, depending on the project and its inherent similarity to other products the users may use the option of further defining the cited art by viewing for example the claims with ready reference to the specification. In certain embodiments the claims may be linked to portions of the specification and/or drawings for ease of understanding exactly what is being claimed and its enablement in the specification. In this manner the present invention may be used to reverse engineer products and avoid infringement thereby providing users and user-viewer designers with design-direction clarity and legal professionals with notice as to legal consequences and strategies that may need attention. Search, retrieval, design and management method and system 100 provides a means whereby R & D may be suitably strategized, directed and work in conjunction with the legal team. Hyperlink 202 is thereby used to assist displaying at least one patent document or portion thereof.

Other users and/or clients may have access to search, design remotely, as shown, through intranet connection 105 and/or internet 107, as shown to see presentations or to work simultaneously in the design of novel engineered products and/or processes. Users of the present invention may include: patent searchers/entities; patent attorneys; patent agents; engineering and design firms; research and development; examiners; patent portfolio managers; marketers; independent inventors, investors and other professionals involved within the field of intellectual property, engineering and research and development.

Analysis process 300 of search, retrieval, design and management method and system 100 may include user-specified parameters that may relate the importance of the product being developed to the product line of the business entity, the available budget, the perceived marketing potential, the competitive entity's product line, marketing potential, patentability potential, statistics of end-users, project costs and timeframes and other such suitable parameters to provide a realistic evaluation of the product as it progresses through the design process. In this way the present invention provides a means whereby management may take ‘snapshots’ of the project as it progresses and have a means for rating its relative worth and potential as based on a variety of user-defined parameters deemed important to the business-entity user. The rating(s) of analysis process 300 may comprise visual comparators such as charts, graphs, percentages, and other such valuation means. In this manner the present invention may also serve as a means for tracking project(s).

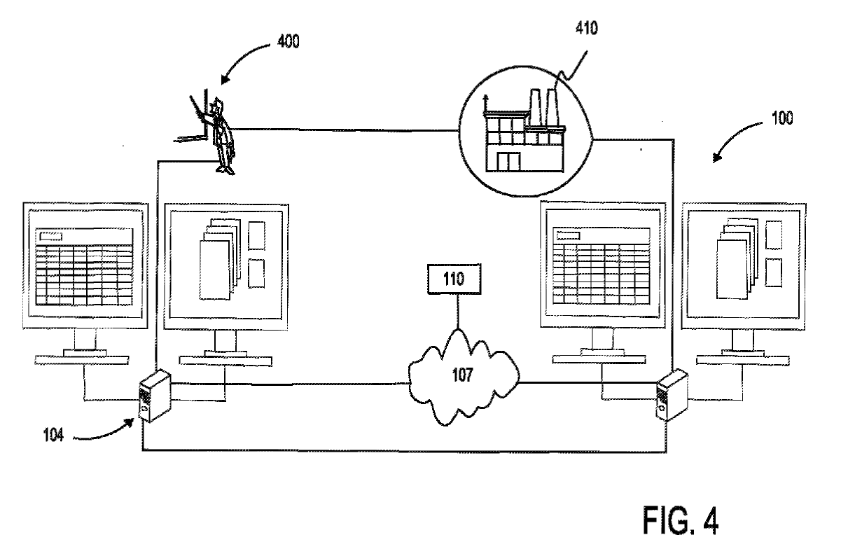

Referring now to FIG. 4, showing a perspective view illustrating a screen shot view 112 of search, retrieval, design and management method and system 100 as used in research and design process 400, according to a preferred embodiment of the present invention of FIGS. 1-3.

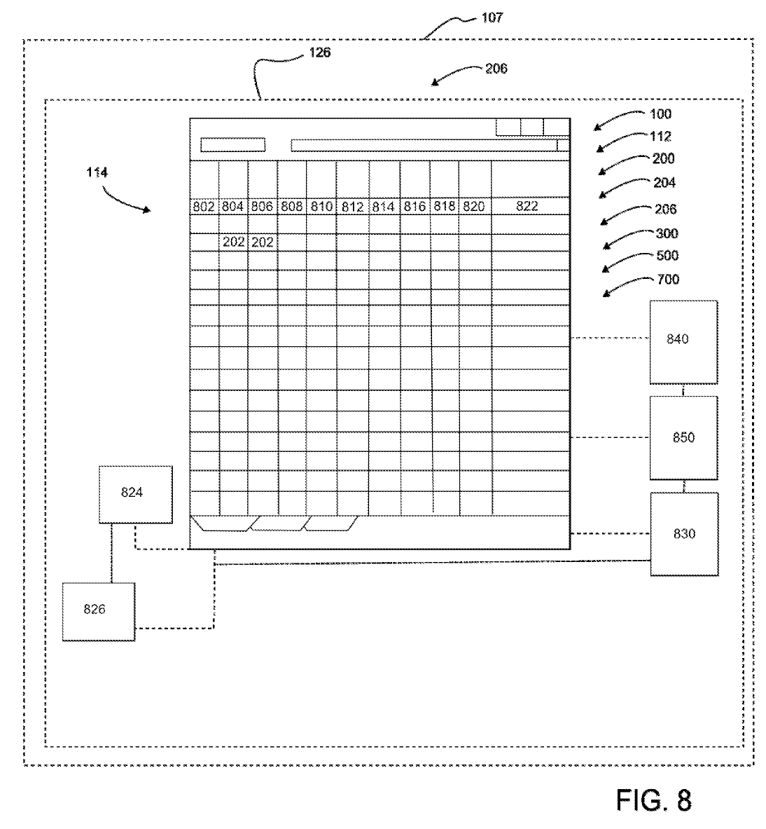

Search, retrieval, design and management method and system 100 may be used in a design process 400 in the following exemplary manner: user(s) may open spreadsheet 206 to view patent information, hyperlinked figures and images; users may assess information through access 126 as described in FIG. 8 to determine relevance, to narrow the potential patents down to a manageable set; next the user may open hyperlinks 202 to visually determine relevance. Next, the user may assess the viability of their proposed invention as to where it may infringe or any further improvements or ‘design-arounds’ that may improve the product. In this manner a user is able to use search, retrieval, design and management method and system 100 to quickly look at the state of the art and present designs and alternate designs to intelligently assist in designing at least one product. The present invention provides a communication means between researchers and developers, engineers, manufacturers and patent legal counsel, investors, and business entity management and further serves to streamline the design process 400 by avoiding potential infringement and promoting clarity of design in the various stages of design process 400.

Using the present invention users may be remote from one another and information may be shared over internet 107 or intranet preferably using intranet connection 105, as discussed and shown in FIG. 1 and alluded to in FIGS. 3-7. For example a patent attorney located at the head office located in another city may communicate with the engineering department or a factory's manufacturing process 410 to assess viability and/or legality of the proposed design. Further, a patent attorney, agent or independent inventor may also use the present invention to make accurate replies to examiners during the patent process by organizing the referenced patents that the examiner may cite as prior art to object or reject the proposed novelties. These may also be recorded on spreadsheet 206 for management during and after prosecution. In the same manner an examiner may use the present invention to track and organize office actions and other tasks. The present invention may provide varying degrees of accessibility so that for example investors, stockholders, accounting, project managers, or other related individuals may view the project at different levels. Security is inherent in the system to allow access according to authority, deemed need, priority and/or preference and may be set and managed by the business entity using search, retrieval, design and management method and system 100.

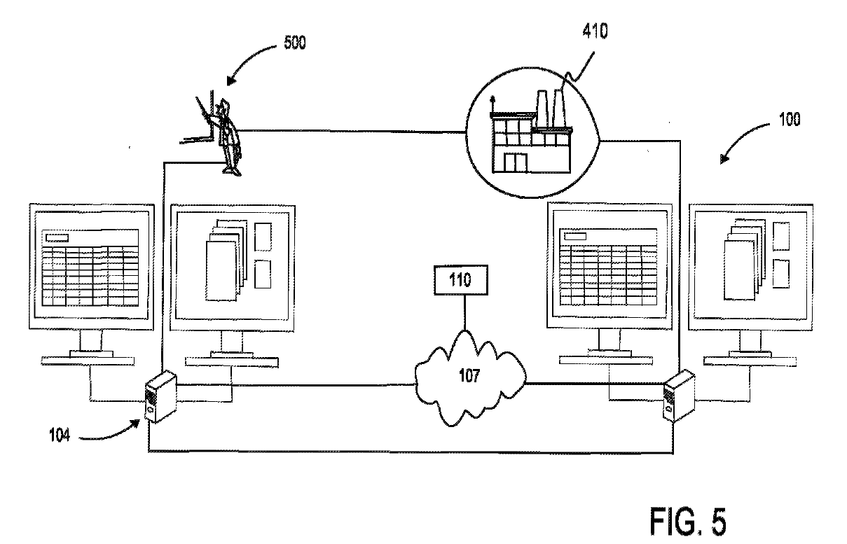

Referring now to FIG. 5 showing a perspective view illustrating screen shot view 112 of search, retrieval, design and management method and system 100 as used in patent writing process 500, according to a preferred embodiment of the present invention of FIG. 1.

Patent attorneys, agents and other intellectual property professionals and independent inventors may find use with the present invention in creating provisional, utility (non-provisional) and design patents to be filed with the various patent and trademark offices as well as with office action responses and other such processes and events. Such individuals are substantially enabled to view related prior art thereby realizing the ability to for example expand and broaden claim coverage. The various elements included on spreadsheet 206 allow quick access between relevant patents to determine background information and other information in issued patents that may be referenced while writing new applications. It should be noted, that due to the nature of the examining process, not all patents and/or publications will be available for viewing on databases 110. The individuals mentioned above should create substantially superior patents in a more cost-effective and efficient manner using the present invention in patent writing process 500, as described herein.

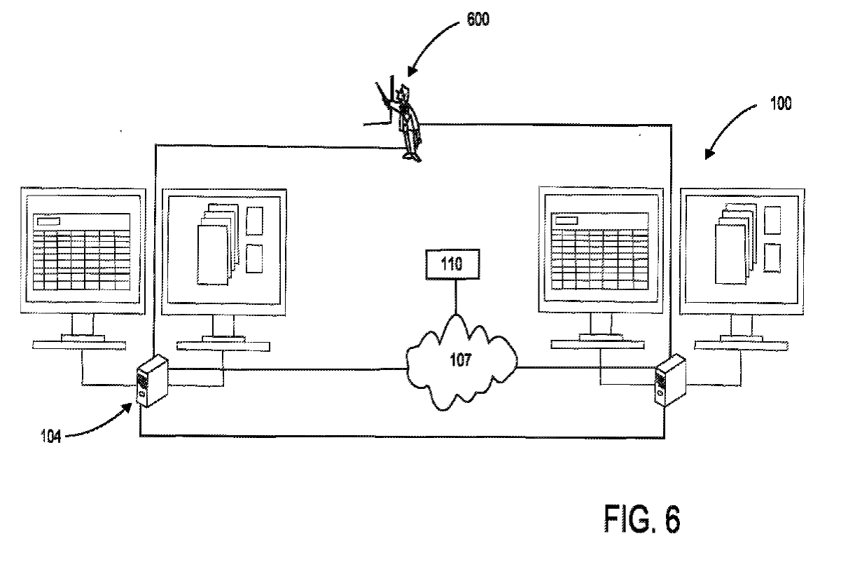

Referring now to FIG. 6 showing a perspective view, illustrating screen shot view 112 of search, retrieval, design and management method and system 100 as used in marketing process 600, according to a preferred embodiment of the present invention of FIG. 1.

Marketing process 600 may use the present invention to market patents or products to potential investors, assignees, licensees, marketing departments, shareholders, competitors and other business and independent entities. Marketing process 600 may include images and text on spreadsheet 206 which may also be preferably linked to presentation program(s) 830 for marketing and presentation, such as PowerPoint or other suitable program and/or word-processing software 840 such as Microsoft Word, and/or to project management software 850, as also discussed in FIG. 8. Presentation program(s) 830 may be used to create a visual ‘sales pitch’ using individual images or in a video form, similar to an advertisement, to potential clients while being able to refer to spreadsheet 206 and word-processing software 840 potentially in different screens or monitors as alluded to in FIG. 3. Word-processing software 840, spreadsheet 206 and presentation from presentation program 830 may also preferably printed out in hardcopy paper-form, unless such information is deemed confidential or if it is essential to take security measure(s) to keep inventions/ideas, trade secrets or design concepts closely guarded. Access 126 is preferably restricted via at least one password to maintain security during the process of using search, retrieval, design and management method and system 100.

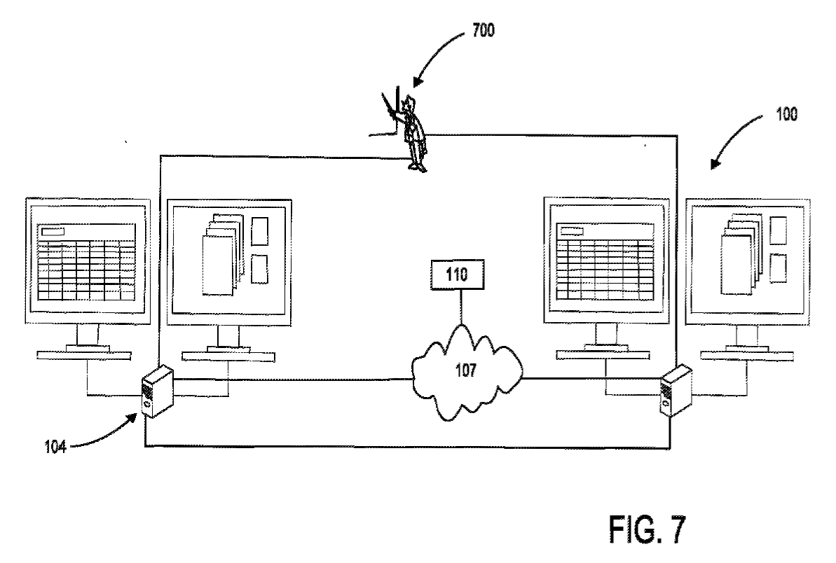

Referring now to FIG. 7 showing a perspective illustrating screen shot view 112 of search, retrieval, design and management method and system 100 as used in management process 700, according to a preferred embodiment of the present invention of FIG. 1.

Management process 700 is a further use of search, retrieval, design and management method and system 100 to preferably aid a portfolio manager with reminders as those described in FIG. 8. Links may be provided to search MPEP and to file wrapper in PAIR or other equivalent information site(s). Spreadsheet 206 of search, retrieval, design and management method and system 100 may be used to compile at least one list for a patent portfolio of the user's company and/or that of the competitor's. In this manner, the present invention may be used to track progress of patents through the entire life of the patent and to gauge relative competitiveness with other products. Timelines for patent progress in research and development may be tracked according to software such as Microsoft Project to include project management means and tracking. In this way project managers may be assisted in developing plans, assigning resources to tasks, tracking progress, managing budgets and analyzing workloads using project management software 850, as also alluded to in FIG. 8.

FIG. 8 is a perspective view, illustrating a screen shot view of the search, retrieval, design and management method and system as used, according to a preferred embodiment of the present invention of FIG. 1.

The present invention may use spreadsheet 206, as shown. Spreadsheet 206 preferably comprises at least the following information: at least one description 802 of the patented invention; at least one patent website link 804; at least one image link 806; at least one patent/application number 808; at least one patent name 810; at least one filing date 812; at least one issue date 814; at least one assignee 816; at least one inventor 818; at least one patent class/subclass 820; at least one abstract 822; and may further optionally comprise provisional serial number; links between related patent documents; at least one claim and/or claim element; at least one contact information for inventor and/or assignee; at least one image; at least one link to file wrapper(s); at least one background; at least one brief summary; at least one detailed description; at least one design patent at least one trademark; and/or non-patent literature in text. It should be noted that the information and links listed are to illustrate how the present invention may be used and any of the above mentioned elements may be hyperlinked or non-hyperlinked. Other suitable material may be added or not used depending on the application, user preference and is not to be interpreted as limiting to the scope of the preferred embodiment(s).

Description 802 of the patented invention preferably comprises descriptive text allowing the user to quickly determine the relevance of the patent. Patent website link 804 preferably comprises at least one hyperlink 202 to patent located on USPTO or Espace or WIPO or other patent office website database 110 for quick and efficient access to the complete patent to view and reference. User simply activates hyperlink 202 to access such information that opens a viewable window.

Image link 806 preferably comprises figures and/or images and/or mosaics from patent website or other database 110 such as Google Patents or other. This feature allows the user and/or research and development engineer to quickly view figures from the patent to determine relevance. Image link 806 may also be used to allow the user to compare various attributes to aid in formulating a final design that will not infringe on another's patent.

Patent/application number 808 and/or provisional patent serial number and/or design patent is preferably listed in spreadsheet 206 so the user may accurately track what patent he/she is viewing. Patent name 810 is included for descriptive benefit and to also accurately track what patent he/she is viewing. In this way the present invention can also be used to track competitor's patent portfolio even perhaps to forecast possible future product developments.

Filing date 812 or publication date is preferably included in spreadsheet 206 to permit the user to accurately determine when the patent was filed. Issue date 814 is preferably included as well so the user may determine if the patent is still current. To increase visibility of such elements text is preferably color coded to stand out if such patent is no longer enforceable so a company may proceed with building or designing the same or similar product. These elements may also be linked to other warnings such as audible warnings or those to be added to a calendar if expiring or requiring a maintenance fee or other to aid in the management functionality as discussed in FIG. 6. Statutory bar dates may also be set up as warnings to notify when critical dates are coming due. Warnings may also comprise emails sent to specified task-responsible individuals.

Any pertinent information with regard to assignee(s) 816 may be included, such as contact information, dates of assignment, assignment history and other such relevant data. In the case of foreign patents applicants may be preferably named. Similar information with respect to inventor(s) 818 may be included. In this way the present invention may be used to track competitive projects/products and or buy, sell, license rights to various intellectual property.

The relevant patent class/subclass 820 that was searched may be included to point to the user where to perform further searching if needed and to show the user the class/subclasses the patent of interest is located in and other places related prior art may be found. Further, the patents cited as prior related art, as those found on the face of the patent may be entered into a cell(s) for quick reference. Preferably, these too are hyperlinked to provide quick access permitting the user to quickly view them to determine relevance.

Abstract 822 may be entered into cells to give the user a more in-depth description to see if the patent may be relevant. Such large sections as this and others may preferably be copied and pasted into the document from the patent/publication to save time, making the process more cost-effective. Abstract 822 may give the viewer a quick synopsis as to what the invention/patent details and entails. The present invention may also comprise a ‘path’ whereby an individual may be guided in a logical progression through a cited document. For example a viewer may first examine abstract 822, then be directed to the brief summary, then to a figures list then to appropriate drawings or portions of the patent or publication. This feature may be user-customizable. Further, claims for example may be linked within the patent to the corresponding portions of the specification using color-coding and/or split screen windows for example to view to compare and assess enablement. Another option may comprise comparing claims from different patents side by side to assess differences and/or similarities, room to operate, infringement, etc. In these ways the present invention serves to provide ease of use for its users and to minimize ambiguity when assessing patents.

Claim sets may be optionally listed therein as a set, individually, and/or broken down into parts to be able to analyze each claim for validity/invalidity. This feature helps to fully visualize and analyze indeed what is being claimed and may be used to check the content of the claims in comparison to the specification to determine enablement. The program may be set up to have the claimed elements show up as different colored text within the specification to quickly assess enablement/accuracy, by for example a user highlighting for example securer in the claims the program will ‘find’ all instances where securer occurs in the specification and possibly the drawings.

Other relevant images may be included such as of the actual product so a person can analyze how well the patent covers the novelty characteristics desired to be protected. A link to at least one file wrapper may be handy for in the case of determining expiration of the patent due to failure to pay maintenance fees as well as other information such as application data, transaction history, patent term extension history, fees, published documents, address & attorney/agent.

The background, brief summary, detailed description, and other desired portions of the patent(s) may be included for reference and related one to the other. For example, as described above, the wording in the claims may be highlighted or text changed to another color in the detailed description or the brief summary to quickly visually check to see if the claims have been enabled and/or embodied. This step is preferably pre-programmed according to user-preference within the present invention

Design patent(s), trademark(s) and/or non-patent literature in text may also be included for information to be analyzed by the user. Build sheet(s) 824 and parts list(s) 826 may be accessed through or accessed by spreadsheet 206 for use in manufacturing and/or engineering and design phases, as also illustrated in FIG. 4. Further, spreadsheet 206 may also be linked to presentation program(s) 830 for marketing and presentation, such as PowerPoint or other suitable program and/or word-processing software 840 such as Microsoft Word, and project management software 850, as also discussed in FIG. 6.

Patent art searchers may also use certain embodiments of the present invention or input information into other embodiments for use as described above. A search results section may be included to show search parameters, to include any search keywords and strings as well as a list of the databases 110 searched, any opinions that may have been reached and at least one disclaimer. Websites visited may also be listed to allow a user to link to a website for example to examine a picture of a product presently being sold.

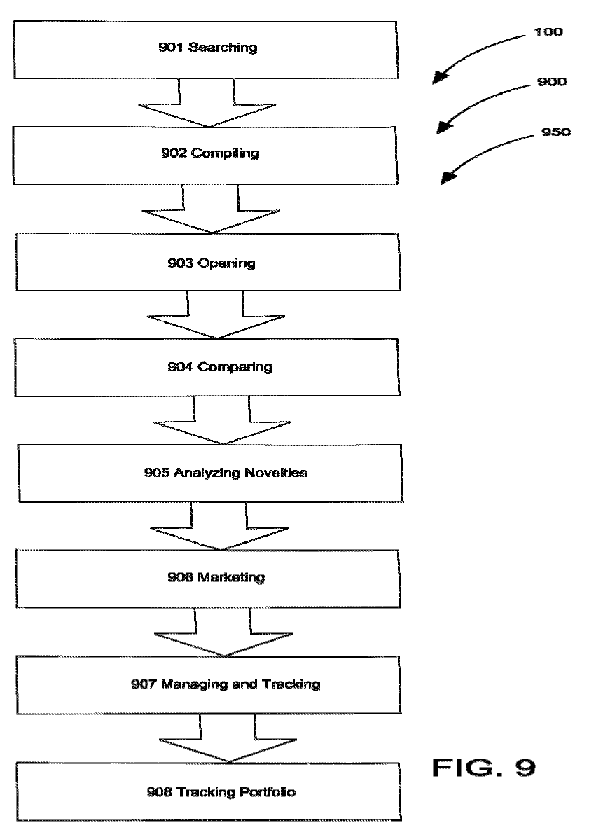

Referring now to FIG. 9 showing flowchart 900, illustrating a preferred method of use 950 of the search, retrieval, design and management method and system 100, according to a preferred embodiment of the present invention of FIGS. 1-8.

Step one 901 preferably comprises at least one searcher searching at least one database 110; Step two 902 preferably comprises the searcher compiling the spreadsheet 206 with relevant data 114 and hyperlinks 202; Step three 903 preferably comprises at least one user/viewer opening spreadsheet 206 and analyzing its contents for relevance; Step four 904 optionally comprises comparing the contents of spreadsheet 206 including the hyperlinked figures, text and claims against a proposed idea/invention or design to analyze for infringement and design accordingly; Step five 905 preferably comprises a patent professional analyzing the proposed novelties in regard to the invention/design and using spreadsheet 206 of search, retrieval, design and management method and system 100 to create at least one patent application using the information provided; Step six 906 preferably comprises marketing proposed invention and/or provisional patent/non-provisional patent using presentation program 830; Step seven 907 preferably comprises management using project management software 850 to track the design/engineering of the idea/product/process; Step eight 908 preferably comprises management using project management software 850 to track patent portfolio through the lifetime of the patent. It should be noted that step four 904 is an optional step and may not be implemented in all cases. Other steps may also be optional depending on project scope or user preference.

It should be noted that the steps described in the proposed method of use 950 can be carried out in many different orders according to user preference. Upon reading this specification, those with ordinary skill in the art will now appreciate that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, using different combinations of software, different individuals accessing search, retrieval, design and management method and system 100 for different reasons and in different capacities, etc., may suffice.

From the foregoing description, it should be appreciated that a preferred embodiment and a method for producing search, retrieval, management method and system 100 are provided and present significant benefits that would be apparent to one skilled in the art. Furthermore, it should be appreciated that a vast number of variations in the embodiments exist. Lastly, it should be appreciated that these embodiments are preferred exemplary embodiments only, and are not intended to limit the scope, applicability, or configuration of the invention in any way. Rather, the foregoing detailed description provides those skilled in the art with a convenient framework for implementing a preferred exemplary embodiment of the invention. It being understood that various changes may be made in the function and arrangement of elements described in the exemplary preferred embodiment without departing from the spirit and scope of the invention as set forth in the appended claims. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A search, retrieval, design and management method and system comprising:
at least one computer system;
at least one accessible database further comprising at least one data;
inputting means comprising at least one inputter connected to said computer system permitting at least one user to input data into said computer system wherein said computer system is connected by an internet communicator to said accessible database; and
wherein said search, retrieval, management method and system provides an interactive search analyzing means to at least one user.

2. The search, retrieval, design and management method and system of claim 1 wherein said interactive search analyzing means comprises engineering design analysis means for use by at least one research and development individual.

3. The search, retrieval, design and management method and system of claim 1 wherein said interactive search analyzing means comprises at least one hyperlink.

4. The search, retrieval, design and management method and system of claim 1 wherein said interactive search analyzing means comprises patent portfolio management means.

5. The search, retrieval, design and management method and system of claim 1 wherein said interactive search analyzing means comprises presenting means for marketing.

6. The search, retrieval, design and management method and system of claim 1 further comprising at least one spreadsheet compiled on at least one spreadsheet application software program wherein at least one spreadsheet is compiled with interactive data.

7. The search, retrieval, design and management method and system of claim 1 further comprising at least one text document compiled on at least one word processing software program that is linked with at least one spreadsheet compiled with interactive data.

8. The search, retrieval, design and management method and system of claim 1 further comprising at least one presentation compiled on at least one presentation software program available to be viewed by at least one viewer-user.

9. The search, retrieval, design and management method and system of claim 1 further comprising at least one project management and tracking means using at least one project management software program.

10. The search, retrieval, design and management method and system of claim 1 further comprising at least one interactive search compiled on at least one combination of at least one spreadsheet application software program, and/or at least one word processing software program, and/or at least one presentation software program, and/or at least one project management software program available to be tracked and maintained in at least one patent portfolio.

11. The search, retrieval, design and management method and system of claim 9 wherein said project management software further comprises alerting means connected to critical patent dates to alert at least one user.

12. The search, retrieval, design and management method and system of claim 10 wherein said alerting means comprises at least one text color change.

13. The search, retrieval, design and management method and system of claim 10 wherein said alerting means comprises at least one audible alert.

14. The search, retrieval, design and management method and system of claim 10 wherein said alerting means comprises at least one text alert in the form of an email.

15. The search, retrieval, design and management method and system of claim 3 wherein said at least one hyperlink is used to assist displaying at least one patent document or portion thereof.

16. The search, retrieval, design and management method and system of claim 3 wherein said at least one hyperlink is used to assist displaying at least one patent figure.

17. The search, retrieval, design and management method and system of claim 3 wherein said at least one hyperlink is used to assist displaying at least one file wrapper.

18. A search, retrieval, design and management method and system comprising:
a computer system;
a internet communicator;
a connecter providing connection means to the internet by hardwired or wireless means;
an accessible database comprising data;
inputting means comprising at least one inputter connected to said computer system permitting at least one user to input said data into said computer system which is connected by said internet communicator to said accessible database;
output means from said computer system including at least one monitor, at least one speaker to alert said at least one user; and
wherein said search, retrieval, design and management method and system provides an interactive search analyzing means using hyperlinks.

19. A method of use for a search, design and retrieval, management method and system comprising the steps of:
at least one searcher searching at least one database;
said at least one searcher compiling the spreadsheet with relevant data and hyperlinks; and
said at least one user opening spreadsheet and analyzing its contents for relevance against at least one proposed potential patent to assist in determining novelty.

20. The method of use of claim 19 comprising the steps of:
said searcher searching said at least one database;
said searcher compiling said spreadsheet with said relevant data and said hyperlinks;
said at least one user opening said spreadsheet and analyzing its contents for relevance against said at least one proposed potential patent to assist in determining novelty;
comparing the contents of said spreadsheet including the hyperlinked figures, text and claims against a proposed invention or design to analyze for infringement and design accordingly;
a patent professional analyzing the proposed novelties in regard to said invention and design and using said spreadsheet to create at least one patent application using information provided;
marketing said proposed invention and/or provisional patent/non-provisional patent using at least one presentation program;
project managing using project management software to track design and engineering of said proposed invention; and
managing using said project management software to track patent portfolio through at least the lifetime of the patent.
